(19) United States
(12) Patent Application Publication
(10) Pub. No.: US 2023/0399271 A1
(43) Pub. Date: Dec. 14, 2023

(54) TREATMENT OF BAUXITE RESIDUE

(71) Applicant: THE UNIVERSITY OF QUEENSLAND, St Lucia, Queensland (AU)

(72) Inventors: Longbin HUANG, Brisbane, Queensland (AU); Fang YOU, St Lucia, Queensland (AU)

(21) Appl. No.: 18/252,510

(22) PCT Filed: Nov. 10, 2021
(86) PCT No.: PCT/AU2021/051328

§ 371 Date: May 10, 2023

(30) Foreign Application Priority Data
Nov. 11, 2020 (AU) 2020904127

(51) Int. Cl. C05F 17/20; C05B 1/02; C05D 9/00; B09B 3/70; B09B 3/65

(52) U.S. Cl. CPC C05F 17/20; C05B 1/02; C05D 9/00; B09B 3/70; B09B 3/65

(57) ABSTRACT

A method for treating bauxite residue contained in a storage facility comprising adding a mixture containing (a) a source of organic carbon, (b) a source of phosphorous or a source of phosphate, (c) a source of calcium, and a source of sulphur or sulphate to the bauxite residue, to thereby promote growth of microbes well adapted to highly saline and alkaline habitat, or to promote growth of marine microbes, or to promote growth of tolerant and marine origin haloalkaliphilic bacteria, or to promote growth of haloalkaliphilic organotrophic bacteria, preferably of marine origin. The method may comprise adding plant material or mulch and superphosphate fertilisers to the bauxite residue.

### TECHNICAL FIELD

The present invention relates to a method for treating bauxite residue.

### BACKGROUND ART

Bauxite is the major ore material used in the production of alumina and aluminium. Bauxite is converted to alumina using the Bayer process, in which the bauxite is subject to high temperature alkaline leaching at elevated pressure to dissolve aluminium into solution. The pregnant leaching liquor is separated from the solid residues, which is formed mainly of undigested bauxite and solid de-silication products that precipitate in the leaching step. Alumina is recovered from the pregnant leach liquor by crystallisation followed by calcination. The solid leach residue, which is variously referred to as bauxite residue, red mud, or alumina refining tailings, contains adherent or residual leach solution of highly alkaline pH. As a result, the bauxite residue is highly alkaline

For every metric tons of aluminium produced from bauxite, 1.5-2.5 tonnes of bauxite residue is generated. Total global storage of bauxite residue is estimated to contain 4 Giga-tonnes of bauxite residue, with this amount increasing by approximately 125 million tonnes per year. The large and continually growing massive volumes of stored bauxite residue highlight the need for effective remediation strategies to manage the environmental impacts of aluminium production and contribute to the industry's sustainability.

As a by-product of the Bayer process used for alumina refining, bauxite residue is highly alkaline (pH greater than 10), highly saline (saturated electrical conductivity greater than 7 mS/cm), highly sodic (exchangeable sodium percentage around 65 to 75%), massive (bulk density of 2-2.5g/cm³) and fine-grained (specific surface area of about 33 m²/g). Bauxite residue pore water is dominated by the cations Na⁺ (major), K⁺, Ca²⁺, and Mg²⁺, and the anions Al(OH)₄⁻, SO₄²⁻, CO₃²⁻ and OH⁻. The major minerals present in bauxite residue include a mixture of residual minerals from the parent bauxite (haematite, goethite, quartz, haolinite, anatase, rutile, undigested gibbsite, boehmite and diaspore) as well as precipitates formed during the Bayer process (perovskite calcite, tricalcium aluminate and zeolitic desilication products such as sodalite and cancrinite). With the exception of perovskite, Bayer process precipitate minerals (particularly alkaline minerals) dissolve slowly and opportunistically during rainfall leaching and weathering in bauxite residue and release salts (Na⁺, Ca²⁺, various anions depending on mineral composition) and alkalinity in the form of CO₃²⁻ and OH⁻ to porewater solutions, maintaining highly buffered and strongly alkaline pH conditions and highly elevated salinity of bauxite residue over a long time.

The chemical and physical properties of bauxite residue pose significant challenges for remediation. Bauxite residues are typically stored in the large tailings ponds that have significant surface area.

Current processes for bauxite residue rehabilitation involved excavating a thick layer of topsoil/subsoil from natural landscapes and transporting it to the storage site for the bauxite residue. A high density polyethylene membrane is placed over the surface of the bauxite residue in the tailings pond and a layer of topsoil/subsoil that has been excavated supplied to a depth of about 100 cm. As a result, the polyethylene membrane and the thick layer of topsoil/subsoil cap bauxite residue and plants can grow in the layer of the applied soil. Unfortunately, this process is very expensive and can be limited by access to topsoil resources within a reasonable distance of the site of the bauxite residue storage. In addition, the placement of polyethylene membrane is not a sustainable solution for the total ecosystem rehabilitation in the long term.

Other workers have attempted to rehabilitate bauxite residue storage facilities by adding green organic matter and gypsum (calcium sulphate) to the bauxite residue. However, the effectiveness and magnitude of pH reduction in the strongly alkaline bauxite residue using these methods are not adequate to permit productive growth and colonisation of pioneer plants. Indeed, the present inventors believe that known methods based upon addition of green organic matter and gypsum are not targeting the core barrier of the solid phase alkalinity (i.e., alkaline minerals) in bauxite residues, can not deplete/remove effectively and significantly the alkali inside the alkaline minerals within a short-term (about 2-3 years), and likely to take longer than 20 years before the treated bauxite residue is capable of supporting productive pioneer plant communities. In addition, the known method has been largely based on the knowledge and method to treat sodic soils in which the alkalinity is formed by carbonate minerals, rather than aluminosilicate minerals containing alkali (i.e., Na) resulting from the Bayer Process.

It will be clearly understood that, if a prior art publication is referred to herein, this reference does not constitute an admission that the publication forms part of the common general knowledge in the art in Australia or in any other countries.

### SUMMARY OF INVENTION

The present invention is directed to a method for the treatment of bauxite residues contained in storage facilities, such as tailings ponds, which may at least partially overcome at least one of the abovementioned disadvantages or provide the consumer with a useful or commercial choice.

With the foregoing in view, the present invention in one form, resides broadly in a method for treating bauxite residue contained in a storage facility comprising adding a mixture containing (a) a source of organic carbon, (b) a source of phosphorous or a source of phosphate and (c) a source of calcium, to the bauxite residue, wherein haloalkaliphilic bacteria are also present.

In one embodiment, the method may further include adding a source of sulfur (S) or sulphate to the bauxite residue. The source of S may comprise a source containing sulphate.

In one embodiment, the bauxite residue contains marine microbes well adapted to highly saline and alkaline habitat, or tolerant microbes. In another embodiment, the method may further comprise adding a source of microbes well adapted to highly saline and alkaline habitat, or marine microbes to the bauxite residues. The source of microbes may comprise seawater and alkaline decant wastewater from bauxite residue dams. The source of microbes may comprise a microbial inoculum enriched/amplified under alkaline and saline conditions.

In embodiments where the bauxite residues are contained in storage facilities located adjacent the ocean, it is expected that the microbes well adapted to highly saline and alkaline habitats or marine microbes will be naturally present or endemic in the bauxite residues, for example, due to sea water spray being blown into the bauxite residues, or possibly due to inundation by seawater. Therefore, where the bauxite residue naturally contains microbes well adapted to highly saline and alkaline habitat, or marine microbes, adding such microbes is an optional step, as such microbes are present in any event.

For treatment at inland sites, one embodiment of the present invention includes forming an inoculum of the desired microbes, and inoculating plant mulch at inland sites by bulking up inoculum containing the microbes and produced from selection and enrichment process. For example, it is possible to produce, say, 1 m³ inoculum using seawater, transport the inoculum to the inland site, multiply the inoculum using local plant mulch to continuously produce and maintain the inoculum on site for long-term use, and use the inoculum to inoculate the bauxite residue, as required. Inoculation of the bauxite residue would t\conveniently occur when adding the plant mulch and fertiliser to the bauxite residue.

In one embodiment, the microbes comprise tolerant and marine origin haloalkaliphilic bacteria or haloalkaliphilic organotrophic bacteria, preferably of marine origin.

Table 2 set out at the end of this specification lists a number of bacteria that can be found in the treated bauxite residue and optionally one or more of those bacteria, especially those derived from marine regions, can be found in the treated bauxite residue.

In one embodiment, the mixture is applied to the bauxite residue by spreading the mixture on top of the bauxite residue in the storage facility and ploughing or otherwise mechanically admixing the mixture into the bauxite residue. In embodiments of the present invention, the mixture may be mixed into the bauxite residue using broadacre farming techniques.

In one embodiment, the source of organic carbon comprises plant biomass residues or plant mulch having relatively high levels of total carbohydrates and an N:C ratio suitable for intensive organic acid production. In one embodiment, the source of organic carbon comprises plant biomass residues or plant mulch having a carbon: nitrogen ratio no higher than 80:1, or from 10:1 to 60:1, or from 20:1 to 40:1. In one embodiment, the source of organic carbon may comprise green mulch or green plant litter. In one embodiment the source of organic carbon may comprise grass or leaves. In another embodiment, the source of organic carbon may be plant material in dried form. In some embodiments, the source of organic carbon comprises plant residues or plant biomass that are carbohydrate and cellulose rich. Woody litters of high lignin and phenolic contents is not particularly useful or much less desirable. The organic matter may be cut/ground into smaller pieces, shredded or used in an as-provided condition.

In one embodiment, the method comprises adding a mixture containing green plant litter and/or green plant biomass and superphosphate fertiliser to the bauxite residue. Superphosphate is a mixture of calcium acid phosphate and calcium sulfate prepared by treating phosphate rock with sulfuric acid and it is used chiefly as a fertilizer. Superphosphate also refers to single- or triple-superphosphate. a mixture that prepared with sulfuric acid and containing 16-45 percent of soluble phosphates and is also used as a fertilizer. The present invention encompasses use of all forms of superphosphate. In this embodiment of the present invention, the superphosphate forms the source of P, the source of Ca and the source of S or SO₄²⁻.

In one embodiment, the present invention uses a slowly dissolving form of phosphorous or phosphate chemicals or phosphate minerals.

In some embodiments, the source of organic carbon, such as plant litter or plant mulch, is added in an amount of from 10% to 60% volume/volume, or from 10% to 50% volume/volume, of the amount of bauxite residue to be treated. For example, if it is desired to treat bauxite residue to a depth of 1 m, from 10 cm to 60 cm of plant litter or plant mulch is spread over the bauxite residue and suitably mixed into the bauxite residue, such as by ploughing or tilling.

In some embodiments, the amending material (the source of carbon and the sources of P and Ca and S or sulphate) is mixed into the bauxite residue to the intended depth of treatment. For example, if it is desired to treat the top 1 m of bauxite residue in a storage pond, the amending materials are mixed in down to a depth of 1 m. Mechanical mixing means are suitably used to mix the amending materials into the bauxite residue to the desired depth. The total amount of amending material to be added to the bauxite residue will depend upon the application rate per metre of depth of bauxite residue or per cubic metre/tonne of bauxite residue and the depth of desired treatment.

In one embodiment, the method of the present invention involves ploughing or tilling the mixture into the bauxite residue and irrigating the bauxite residue. Irrigation may be required if the bauxite residues are stored in storage facilities located in an arid environment. In other embodiments, where bauxite residue storage facilities are located in wetter environments, there may be sufficient rainfall to mean that regular irrigation is not required.

In one embodiment, the present invention comprises mixing phosphorous-rich calcium-minerals, such as superphosphate, to the bauxite residue. The amount of phosphate-rich calcium-minerals may be added to the bauxite residue in an amount of from 1 to 30% weight/weight ratio, or from 3 to 30% weight/weight ratio, to the bauxite residue. For example, to treat one tonne of bauxite residue, from 30 kg to 300 kg of phosphate-rich calcium-minerals, such as superphosphate, may be added.

In order to determine the application rate per hectare per area, the weight of the red mud may be determined by taking an estimate of the bulk density of the bauxite residue in the storage facility, and then multiply that by the surface area of the storage facility and the desired depth of treatment. For example, to treat a storage facility having a surface area of 100 m² to a depth of 0.5 m, the bauxite residue is estimated to have a dry bulk density of 1.8-2.0 tonnes/m³. The volume to be treated is 100 m³ and the total weight to be treated is 100 tonnes (using a bulk density of 2.0 tonnes/m³). This will require an application of from 5 tonnes to 30 tonnes to that storage facility, which represents an application rate of from 0.05 tonnes to 0.30 tonnes per square metre.

In one embodiment, the phosphorous rich calcium minerals, such as superphosphate, contain from 5 to 10% P, by weight (calculated on the basis of P present). The phosphorous rich calcium minerals, such as superphosphate, may have a phosphorous solubility of greater than 50% (in other words, at least 50% of the phosphorous material in the superphosphate is soluble in water), or greater than 60%, or greater than 70%, or greater than 80%. Commercial grade superphosphate normally has a P solubility of about 86%. The phosphorous or phosphate may be slowly solubilized to release the P into the treated bauxite residue or red mud over an extended period of time. In some embodiments, the soluble P should be expected to last from 1 to 2 years before being fully dissolved and immobilized with the loss of biological efficacy.

In one embodiment, the source of organic carbon, the source of phosphorous or phosphate and the source of calcium are mixed with the bauxite residue to a desired depth. The desired depth may be from about 20 cm to about 5 m, or from about 50 cm to about 2 m, or from about 50 cm to about 1.5 m, or from about 50 cm to about 1 m. Experimental work conducted by the inventors to date has used a depth of about 50 cm. Broadacre farming techniques, such as ploughing, tilling or slotting may be used to facilitate the mixing into the bauxite residue. The source of phosphorous or phosphate and the source of calcium may be applied using farming equipment used for spreading fertiliser.

In one embodiment, the method of the present invention comprises preparing a mixture comprising the source of organic carbon, the source of phosphorous or phosphate and the source of calcium and applying that mixture to the bauxite residue. In this embodiment, the mixture comprising the source of organic carbon, the source of phosphorous or phosphate and the source of calcium is formed prior to applying to the bauxite residue. In another embodiment, the source of organic carbon is applied to the bauxite residue separately to the source of phosphorous or phosphate and source of calcium. For example, the source of organic carbon may be applied to the bauxite residue and then the source of phosphorous or phosphate and the source of calcium may be applied. In another embodiment, the source of phosphorous or phosphate and the source of calcium is applied and the source organic carbon is subsequently applied. For ease of application, it is preferred that the source of organic carbon is pre-mixed with the source of phosphorous phosphate and source of calcium or that they be applied together.

In a likely commercial embodiment, the present invention provides mixing plant litter or plant biomass and superphosphate fertiliser into at least an upper part of a bauxite residue contained in a bauxite residue storage facility for rehabilitation purposes of vegetation/plant communities. The plant litter or plant biomass (fresh or dry) and superphosphate fertiliser are mixed to a desired depth in the bauxite residue.

In another likely commercial embodiment of making fertile soil to improve other soil/land of low quality, the present invention provides mixing plant litter or plant biomass and superphosphate fertiliser into at least 1 m layer of bauxite residue in a storage facility for developing fertile soils to be excavated and transported away and applied at another location for improving marginal cropping/pasture/agroforest soil/land. The plant litter or plant biomass (fresh or dry) and superphosphate fertiliser are mixed to a desired depth in the bauxite residue.

The bauxite residue that is treated in the present invention is normally stored in a bauxite residue storage facility. This may comprise an impoundment, a tailings dam, a tailings pond or the like. The bauxite residue in the storage facility is suitably sufficiently dried so that vehicles, such as tractors, ploughs and the like, can move thereon. Suitably, the bauxite residue storage facility is an impoundment, a tailings dam or a tailings pond that no longer has further red mud or bauxite residue added thereto. The present invention enables the bauxite residue to be treated in-situ and it does not require use of treatment vessels.

In one embodiment, the method may include the step of inoculating plant material with tolerant and marine origin haloalkaliphilic bacteria and allowing the tolerant and marine origin haloalkaliphilic bacteria to be enriched/amplified/build up in the plant material to form an inoculum and subsequently adding the inoculum to the bauxite residue. In one embodiment, the tolerant and marine origin haloalkaliphilic bacteria are added to plant material and the plant material allowed to sit for from 1 week to 4 weeks, or from 2 weeks to 4 weeks, or for about 2 weeks, the build-up the tolerant and marine origin haloalkaliphilic bacteria in the plant material. Longer periods of time may be used, if desired, but the inventors believe that 2-4 weeks should be sufficient time to allow the microbial biomass to increase the desired levels. The tolerant and marine origin haloalkaliphilic bacteria may be added to the plant material by adding seawater or alkaline and saline wastewater, such as local alkaline and saline wastewater decant from the bauxite residue storage facilities, to the plant material. The microbial biomass of desired microbes can then quickly build up in the plant material and effectively form a composted plant mulch. The composted plant mulch containing the desired bacteria or inoculum can then be added into the method of the present invention.

Without wishing to be bound by theory, it is believed that using the pre-composted plant material containing enhanced amounts of tolerant and marine origin haloalkaliphilic bacteria can quickly build up microbial biomass and microbial abundance in the bauxite residue and increase the efficacy of the treatment or allow the treatment effects to be achieved in a shorter time.

In one embodiment, the inoculum or composted plant mulch can be added to the other organic material added to the bauxite residue, or applied separately to the bauxite residue to the other components added by the method of the present invention. It will be appreciated that the inoculum or composted plant material is desirably added with or at a time close to adding of the other components to the bauxite residue.

In one embodiment, the inoculum or composted plant mulch comprises from 0.1 to 10% by volume of the source of organic material or plant mulch added to the bauxite residue.

Without wishing to be bound by theory, in embodiments of the present invention, it is believed that the tolerant and marine origin haloalkaliphilic bacteria in or added to the bauxite residues work together with the organic and P—Ca-Sulfur rich fertilisers to achieve the rapid de-alkalization and neutralization to break through the extreme alkaline pH barrier (9.5-13) present in the bauxite residue. Once the pH reduces to 9.5 or below, many other natural bacteria and fungi can start to live and grow in the treated bauxite residue.

In another embodiment, the present invention further includes adding elemental sulphur to the bauxite residue. The elemental sulphur may be added from 12 to 18 months after the original treatment. It is believed that adding elemental sulphur can further lower the pH from 8-9 to 6-7 through microbial sulphur oxidation and acidification. Some of the haloalkaliphilic bacteria can also oxidize sulphur with the supply of organic carbon (in the plant mulch) as part of the original treatment.

The elemental sulphur may be added in an amount of from 1-10% S weight/weight of the bauxite residue, or from 100-2000 kg S/hectare. The addition rate of elemental sulphur will depend upon the mineralogy and depth of the bauxite residues to be treated and the local climate (temperature, rainfall). Adding elemental sulphur may be beneficial for improving treatment efficacy, turnaround time and reducing costs since P-fertiliser can be expensive.

In one embodiment, the step of adding a mixture containing (a) a source of organic carbon, (b) a source of phosphorous or a source of phosphate, (c) a source of calcium, and a source of sulphur or sulphate to the bauxite residue may be repeated one or more times. It is envisaged that any repeat of this step is likely to occur at intervals of from 6 months to 24 months from the previous treatment. In another embodiment, elemental sulphur is added to the bauxite residue 12-18 months after the initial treatment.

In a second aspect, the present provides a method for treating bauxite residue contained in a storage facility comprising adding a mixture containing (a) a source of organic carbon, (b) a source of phosphorous or a source of phosphate, (c) a source of calcium, and a source of sulphur or sulphate to the bauxite residue, to thereby promote growth of microbes well adapted to highly saline and alkaline habitat, or to promote growth of marine microbes, or to promote growth of tolerant and marine origin haloalkaliphilic bacteria, or to promote growth of haloalkaliphilic organotrophic bacteria, preferably of marine origin.

In a third aspect, the present invention provides a soil amendment for amending bauxite residue in a storage facility, the soil amendment comprising a source of organic carbon and a source of phosphorous or phosphate and a source of calcium. In one embodiment, the soil amendment comprises green biomass, such as plant litter or plant mulch, and superphosphate.

In one embodiment of the third aspect of the present invention, the soil amendment may also include a source of S, such as a source of sulphate.

In one embodiment, the soil amendment includes superphosphate fertiliser. The superphosphate provides the source of P, the source of Ca and the source of S/sulphate.

The soil amendment may further comprise a population of one or more microbes well adaptive to highly saline and alkaline habitats, or one or more marine microbes. However, as mentioned above, if the bauxite residue storage facility is located in close proximity to the ocean, the marine microbes may be naturally present in the bauxite residue.

In one embodiment, the population of one or more marine microbes may be inoculated into the soil amendment by soaking the organic biomass soil amendment in seawater. In another embodiment, an inoculum of marine microbes can be added to the soil amendment.

In a preferred embodiment, haloalkaliphilic organotrophic bacteria are present in the treated bauxite reside, either as part of a natural or endemic microbial population in the bauxite residue or by way of being introduced with the amending agents.

In a fourth aspect, the present invention provides a soil amendment for amending bauxite residue in a storage facility, the soil amendment comprising a source of phosphorous or phosphate and a source of calcium, and haloalkaliphilic organotrophic bacteria.

In one embodiment, the soil amendment further comprises organic matter, such as green biomass, such as plant litter or plant mulch.

In one embodiment of the fourth aspect of the present invention, the soil amendment may also include a source of S, such as a source of sulphate.

In one embodiment, the soil amendment includes superphosphate fertiliser. The superphosphate provides the source of P, the source of Ca and the source of S/sulphate.

The soil amendment includes haloalkaliphilic organotrophic bacteria, such as a population of one or more microbes well adaptive to highly saline and alkaline habitats, or one or more marine microbes.

In one embodiment, an inoculum of haloalkaliphilic organotrophic bacteria, such as marine microbes, can be added to the soil amendment.

In one embodiment of the fourth aspect of the present invention, the soil amendment comprises packages of bags comprising the source of phosphorous or phosphate and the source of calcium, and the haloalkaliphilic organotrophic bacteria. In one embodiment, the soil amendment of the fourth aspect of the present invention comprises superphosphate fertiliser and haloalkaliphilic organotrophic bacteria.

In a preferred embodiment, haloalkaliphilic organotrophic bacteria are present in the treated bauxite reside, either as part of a natural or endemic microbial population in the bauxite residue or by way of being introduced with the amending agents.

Table 2 set out at the end of this specification lists a number of bacteria that can be found in the treated bauxite residue and optionally one or more of those bacteria, especially those derived from marine regions, can be included in the soil amendment of the third and fourth aspects of the present invention.

The soil amendment may be in the form of a composition or a mixture of the ingredients.

The soil amendment may be applied to the bauxite residue by spreading the soil amendment on top of the bauxite residue and ploughing or tilling or otherwise mixing the soil amendment into the bauxite residue. The soil amendment may be applied at a depth of up to 50 cm, all to a depth of from 10 cm to 50 cm, in order to treat 1 m depth of bauxite residue. In another embodiment, the soil amendment can be sprayed as a form of soil suspension onto the bauxite residue.

Without wishing to be bound by theory, the present inventors have postulated that in embodiments of the present invention the use of phosphorous rich calcium minerals in combination with organic biomass stimulates saline/alkaline tolerant microbes that result in the metabolism of organic carbon and fixation of nitrogen, thereby rapidly catalysing the weathering of alkaline materials in the bauxite residue, release of soluble sodium into porewater for effective leaching and neutralisation, causing the formation of organic molecules, such as organic acids, and water stable aggregates and resulting in the formation of soil structure. This leads to rapid and cost-effective soil formation within 2-3 years of initial treatment, with that soil being capable of supporting productive halophytic plant materials.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF THE DRAWINGS

FIG. 1 shows one-dimensional ATR-FTIR spectra in the 800-2000cm-1 region of representative biofilms of the bauxite residues from the CK (dotted) and Grass+P (bold line) treatments;

FIG. 2 shows a boxplot of total nucleic acids in the biofilms from CK and Grass+P;

FIG. 3 shows a box plot of protein levels in the biofilms from CK and Grass+P;

FIG. 4 shows species richness and evenness (Shannon index) and FIG. 5 shows beta diversity using unconstrained principal coordinates analysis PcoA) based on Bray-Curtis distance of virtual communities. Relative abundance of bacterial communities was square root transformed before calculating the Bray-Curtis distance. Colours presenting different treatments with 95% confidence ellipses;

FIG. 6 shows the phylum distribution of bacterial communities in the biofilm from

the CK and Grass+P treatments.

FIG. 7 shows bauxite residues attached to biofilm in the treatment of Grass+P have lower desilicated alkaline buffering minerals (e.g., sodalite), and

FIG. 8 shows interface between bauxite residues and biofilm and their impacts on mineral liberation and associated element distribution in biofilm layers.

### DESCRIPTION OF EMBODIMENTS

### Example 1

A field trial using lysimeters (1×1×1 m) was established at a decommissioned Rio Tinto Aluminium bauxite residues dam (S12.20, E136.73) located in Gove Peninsula (North East Arnhem land, Northern Territory, Australia), to demonstrate the effectiveness of organic biomass and phosphate amendments in concert with marine organisms for bauxite residue dealkalization, pH neutralisation and soil formation. The bauxite residues were admixed with Rhodes grass mulch and super-phosphate fertiliser, and it is expected that marine-origin bacteria would have naturally inoculated in the amended residues due to the trial site's proximity to the coastal shore (<1 km).

After several months of field incubation under irrigated conditions, the alkaline pH condition was irreversibly neutralized to pH 8.1 in the residues amended with grass mulch and P fertilizer (containing 19% Ca, 11% S and 8.8% P, applied at 7% w/w rate), where Rhodes grass naturally emerged, but not in those without any amendment. The amended bauxite residues also exhibited formation of thick surface biofilms, which have never been reported elsewhere before. The rate and extend of pH neutralization of the grass mulch and P fertilizer amended residues were significantly higher than those amended with gypsum (containing 19% Ca and 15% S, applied at 10% w/w rate) (pH 9.3).

### Methodology

Both bauxite residue and biofilm samples were collected from above field trial from the treatment, with the following treatments being applied: 1) CK (control): Bauxite residue without any amendment; and 2) Grass+P (20% v/v grass mulch and 7% w/w super-P), after 12-month of field incubation and regular irrigation. The bauxite residue used to set up this field trial was sourced from newly deposited pond 5 of RTA Gove refinery, which mainly consisted of iron (Fe) and aluminium (Al) minerals including, hematite (11.8%), quartz (9.1%), sodalite (6.8%), and boehmite (4.7%). Initial bauxite residue porewater pH was 11.7 and electrical conductivity (EC) 9.4 mS cm⁻¹, with a high level of potential alkalinity (≈1M H+ kg⁻¹) in the solid residue, and low levels of inorganic carbon (C) (0.4%), organic C (<0.1%), mineral nitrogen (N) (20 mg N kg⁻¹), and inorganic phosphorous (P) (0.8 mg kg⁻¹ water extractable P).

Naturally formed biofilms were gently scraped from the surface layer (0-1 cm) of bauxite residue across three separate areas of 10×10 cm, from the two contrasting treatments (i.e., CK and Grass+P), at least 20 cm away from any grass canopy. The bauxite residues attached to each biofilm sample were carefully removed for mineralogical, microstructural and geochemical analysis. Biofilms and bauxite residue samples were stored at approximately 4° C. in the dark during transport to the laboratory, then further sub sampled for geochemical analysis. Biofilm subsamples were frozen at −80° C. prior to DNA and protein extraction.

### Results

Bauxite residue particles adhered to each of the two treatment biofilms had distinctly different geochemical characteristics. After field incubation for 12-months (including 6 month of simulated wet season using irrigation), the pH in the surface residues of the Grass+P treatment significantly decreased to 8.1 (i.e., moderately alkaline) from the initial pH 12. Bauxite residue particles attached to biofilms in the CK treatment also had a lowered pH of 10.1 after field incubation and irrigation. The strong pH neutralization in the Grass+P treatment resulted in much reduced Al solubility compared to both the CK treatment and the initial bauxite residue material.

The initial bauxite residue was extremely saline with EC of 9.4 mS cm⁻¹ (EC1:5 water), attributable in large part to high concentrations of water-soluble Na (7405 mg kg⁻¹). The irrigation induced leaching removal of large amounts of water-soluble Na from the surface residues in both CK and Grass+P treatments. Therefore, at the time of sampling, the bauxite residues attached to biofilms from Grass+P treatment had a much-lowered EC of 2.3 mS cm⁻¹ and contained of 1236 mg water-soluble Na kg⁻¹ air-dry wt. In contrast, EC and water-soluble Na of the surface residues in the CK treatment were reduced to 0.4 mS cm⁻¹ and 658 mg kg⁻¹, respectively. While water-soluble Na in the Grass+P residues was higher than those of the CK residues, the amount of exchangeable Na was less than half. This is consistent with the expected differences in de-alkalization effects between the two treatments. The qXRD analysis revealed that the bauxite residue from the Grass+P treatment contained 3.9% sodalite, in contrast to 7.5% in the CK and 7.8% in the original bauxite residue.

The biofilms from the CK and Grass+P treatments exhibited contrasting visual appearance in colour, thickness, and morphology. Biofilms from CK treatment showed a very smooth and moist surface with a thin, reddish layer (20-40 μm) adhering loosely to bauxite residue minerals. In the Grass+P treatment, the biofilms were greenish in colour and presented rough surfaces with many microscale bumps and protrusions, and tightly adhered to a thick layer of BR matrix. This composite layer of BR minerals and biofilms was as thick as 200-500 μm with a dense matrix profile.

The elemental mapping of biofilm-bauxite residue composites confirmed biofilm layers were enriched with Ca and P in the bacterial cells. Grass+P treatment significantly elevated the levels of available P in the bauxite residue presumably contributing to the enhanced biofilm growth and total biomass. There are induced Al/Si containing mineral in the interface between biofilm and bauxite residues, which is consistent with the elevated conductivity and reduced sodalite in treatment of Grass+P with better growth of biofilm.

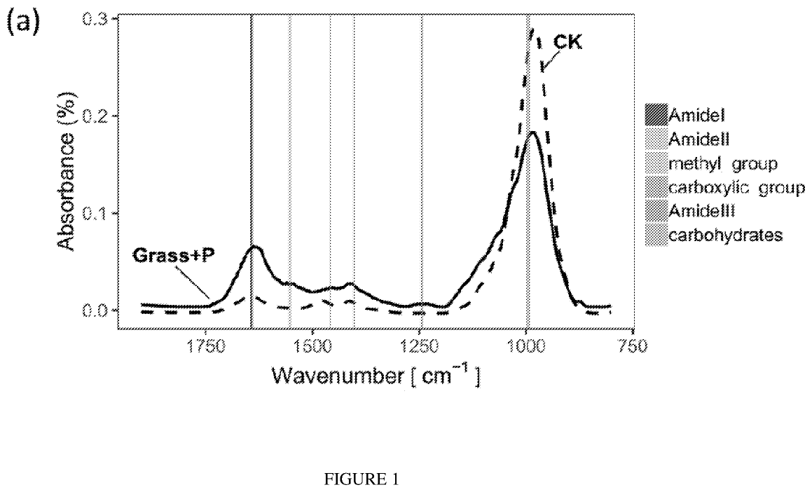

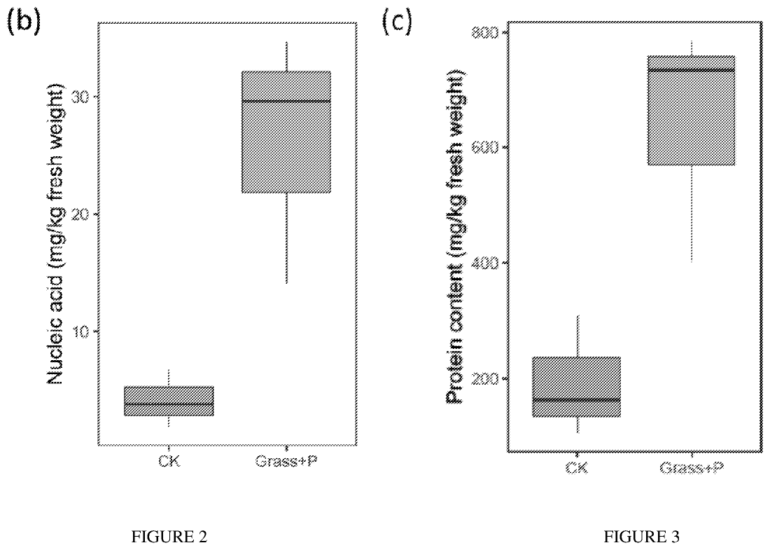

The FTIR spectra of the EPS extracted from representative biofilms confirmed differences in EPS chemical composition between CK and Grass+P treatments (see FIGS. 1 to 3). Wide and intensive peaks in the region of 980-1200 cm-1 (vibrational stretching of O—H and C—O, the two most common functional groups in carbohydrates) was strongest for CK treatment EPS, whilst peaks at 1640 cm-1 and 1540 cm-1 (vibrations of the —CONH— group of Amide I and Amide II in proteins) were strongest for the Grass+P treatment EPS. A weaker peak at 1250 cm-1 (deformation vibration of C—O from carboxyl groups and stretching vibration of P—O groups) was also observed for the Grass+P treatment EPS. This suggests that the EPS of Grass+P biofilms were relatively enriched in N-containing organic compounds. Reinforcing this analysis, DNA and protein extractions found that the Grass+P biofilms were more abundant in these dominant N-containing biomolecules.

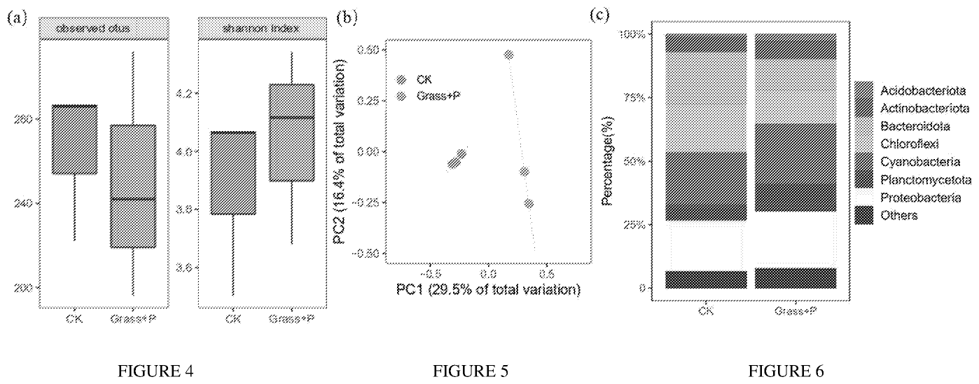

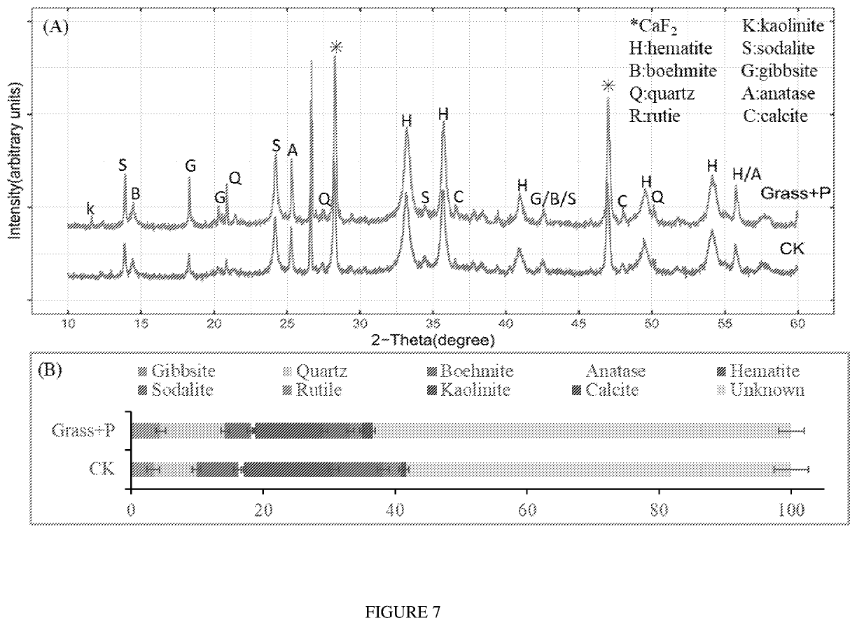

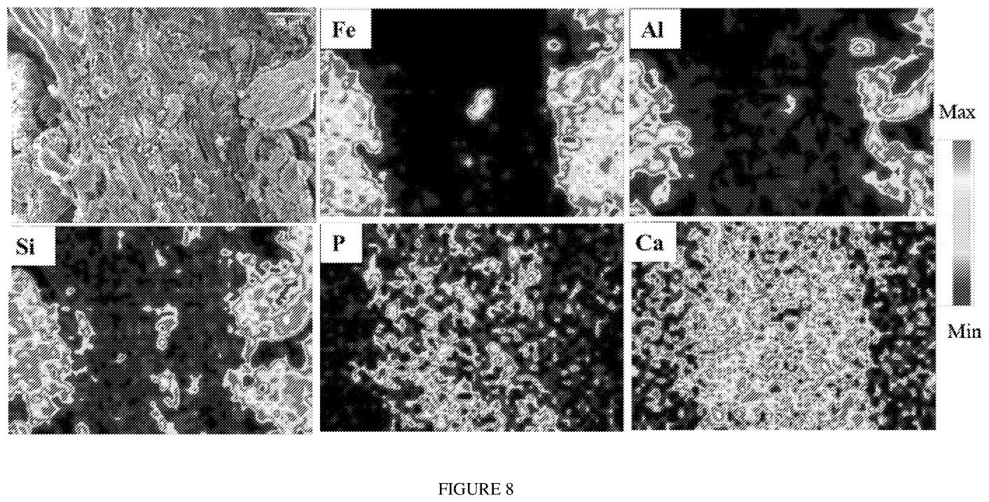

Phylogenetic profiling of bacterial communities in the biofilms revealed a total of 161,626 high quality sequences. Rarefaction analysis indicated that the sequencing depth well captured the diversity of the bacterial communities present in all biofilms. Between a relatively high levels of diversity of bacterial communities, ranging from 196 and 312 OTUs were detected across samples, without significant difference in the richness of OTU numbers or Shannon index between the CK and Grass+P treatments. Bacterial community composition differed significantly between the CK and Grass+P treatment biofilms, but both were dominated by a mixed of autotrophic bacteria (Cyanobacteria) and heterotrophic bacteria (Bacteroidetes, and heterotrophic Proteobacteria such as Rhizobacter and Sphingomonas spp.). Genus-level community compositions and the intimacy of ecological interactions also varied between CK and Grass+P biofilms. Co-occurrence network analysis revealed distinct clusters reflecting the unique community structures and ecological interactions between CK and Grass+P treatments. For example, many of the most abundant co-occurring OTUs in CK the biofilm community formed a highly condensed cluster, dominated by Flexibacter spp. (15.6%, best match with Flexibacter flexilis, organoheterotroph mainly from marine environment), Chloroflexi bacterium OLB13 (9.6%, uncultured anammox nitrite-oxidizing bacteria), and Nostoc spp. (5.5%, best match with Nostoc sp. AT703, cyanobacteria forms biocrust in hot and drylands with capability to fix atmosphere carbon and nitrogen). Bacteria in biofilm from CK treatment have abundant marine source organoheterotrophic genera, which forms highly clustered microbial module. Marine source organoheterotrophic OTUs (e.g., Pseudofulvirnonas spp., 5.2%) were also more abundant in the biofilms from treatment of Grass+P, as well as plant-root associated Proteobacteria (e.g., Rhizobacter spp. 3.4%) compared to those in CK treatment. The gene resource with application potential to survive and drive organic matter metabolisms has been summarized in Table 2. FIGS. 4 to 6 show the relevant results.

### Discussion

Abundant and vigorous microbial biofilms were induced by grass mulch and phosphorus addition. The biofilms are clearly responsive to the combined amendments of grass mulch and P fertiliser under irrigated (simulating tropical wet season) and tropical climatic conditions. Vigorous biofilm establishment is highly correlated with improved soil-like conditions in the bauxite residues, and natural colonization by pioneer plant species occurred in less than 2 years under field conditions.

Microbial community beta-diversity, cell growth, and EPS production were substantially increased by the inputs of organic biomass (e.g., grass mulch rich in carbohydrates and some N) and macronutrients (particularly P). The observed high bacterial biodiversity was reflected in the diverse physiological functions represented by the Grass+P biofilm proteome. As revealed by network and proteomics analyses, Cyanobacteria were the key component in the bacterial network, active as the primary producer capable of photosynthesis and TCA carbon fixation pathway. Many are and also capable of fixing atmospheric N₂ (e.g., in heterocyst) to drive biomass production. Therefore, they may competitively colonise N-limiting ecosystems, such as the N-deficient bauxite residue. However, the inputs of grass mulch and P fertilizer likely also contributed to the growth of Cyanobacteria in the Grass+P treatment, by elevating the supply of carbohydrates, organic N and available P. It is known that P deficiency limits the growth and functions of filamentous Cyanobacteria (e.g., Leptolynbgya spp. Nostoc spp.,), and many species have the ability to incorporate C and N from extracellular organic compounds.

The amended Grass+P bauxite residue also provided other organoheterotrophs with increased substrate supply, both directly from the grass mulch and super-phosphate, and possibly indirectly, through symbiotic species interactions. The SE-SEM and FISH examination revealed that bacteria other than cyanobacteria (with smaller cell sizes, without green florescence) tended to aggregate around or attach to the walls of the filamentous cyanobacteria in the bauxite residue biofilms. In this partnered system, cyanobacterial carbon overflow could become substrates to be rapidly utilized by symbiotic organoheterotrophs in the biofilms. This commensalism between cyanobacteria and organoheterotrophs may have sustained the biofilm community as a “self-carbon-sufficient” system in the amended bauxite residue in the present case.

The EPS in the biofilms of Grass+P treatment was enriched with N-containing molecules and Ca and P derived from the added super-P. Moreover, in these biofilms, proteins participating in cell growth pathways were more diverse, than those of the CK. The Grass+P treatment stimulated the growth of organoheterotrophic soil-source Proteobacteria (e.g., Rhizobacter spp., Pseudofulvimonas spp.) and aerobic Bacteroidetes (e.g., Rhodocytophaga spp.,). Overall, the biofilms in the Grass+P amended bauxite residues showed an elevated metabolic capacity to decompose complex organic compounds, compared to the CK treatment. For instance, Bacteroidetes (known as degraders of complex biopolymers) were relatively more abundant in the biofilms of Grass+P treatment, and produced a more of types of proteins. Proteins associated with other presumed organoheterotrophs (e.g., Actinobacteria and Proteobacteria) in the Grass+P biofilms were also more diverse than those of the CK treatment. In addition, biofilms of the Grass+P treatment hosted a higher number of proteins involved in N metabolisms (e.g., Polynucleotide phosphorylase, Glutamine synthetase, Agmatinase, Glycine cleavage), P metabolism (e.g., Alkaline phosphatase), and respiration (e.g., 6-phosphogluconate dehydrogenase), than the control. These results suggest grass mulch and P-fertiliser amendment stimulates an improved functional capacity for complex carbohydrate decomposition and production of organic by-products such as organic acids. Organic acid production should then lead to complexation of Al—Si minerals and rapid de-alkalization of sodalities (i.e., the solid phase alkalinity) in the bauxite residues, and neutralisation of soluble alkali in porewater.

The multi-species cyanobacteria-organoheterotrophs in the biofilms may provide a sustainable mechanism for continuous supply of organic metabolites with functional ligands of high affinity towards Al—Si minerals. This organic ligand complexation with the Al—Si cage of alkaline minerals such as sodalite is a critical process to facilitate the hydrolysis of the alkali (Na⁺). In the present study, the alkaline and saline tolerant biofilms boosted by Grass+P inputs significantly stimulated the weathering of minerals in the bauxite residues, as indicated by the drastically elevated levels of soluble Na, K, Ca, and Mg compared with the control (Table 1). Among the prominent bauxite residue minerals attached to the biofilms, Fe/Ti-containing minerals (e.g., hematite, rutile, anatase) appeared stable, but not Al/Si/Na containing minerals (e.g., sodalites) and Ca-rich P fertiliser minerals (i.e., super-P). In particular, Grass+P treatment lowered the relative abundance of sodalites by 50%, with much reduced exchangeable Na in resultant mineral phase, compared to those in the CK without inputs (Table 1). Simultaneously, the pH in the CK treatment remained stable after 24 months incubation, while the pH in the Grass+P treatment dropped from 9.05 to 6.10 by the end of 24 months field incubation. Therefore, this treatment eliminated the resurgence of persistent solid-phase alkalinity in the bauxite residues, resulting in pH neutralization and allowing leaching removal of excess Na in porewater under intensive rainfalls and/or field irrigations. Most excitingly, the demonstrated biofilm response and associated microbial de-alkalization are so easily stimulated by local grass mulch and a common crop fertiliser superphosphate. The resultant engineered soil in the Grass+P treatment supported natural colonization of pioneer plant species (Rhodes grass) which completed full life cycle within 2 years under field conditions.

TABLE 1
comparison of selected geochemistry or residue biofilms set
for the treatment of CK and Grass + P and the relationship
with bacterial communities as revealed by Mantel test.

| | | | | Mantel- | Mantel- |
|---|---|---|---|---|---|
| | Treat- | Treat- | | Carol | Carol |
| | ment ^{a} | ment | T-test^{b} | test^{c} | test^{c} |
| Parameter | CK | Grass + P | p-value | r | p |
| pH(_{1:5 water}), | 10.13 | 8.06 | 0.001*** | 0.975 | 0.0222* |
| Electrical | 0.4 | 2.3 | 0.011* | 0.978 | 0.0097** |
| conductivity | | | | | |
| (mS/cm) | | | | | |
| NO₃—N (mg/kg) | 2.6 | 9.3 | 0.252 | 0.480 | 0.3083 |
| NH₄—N (mg/kg) | 11.2 | 17.3 | 0.620 | 0.339 | 0.5753 |
| Available P | 7.2 | 273.2 | 0.007** | 0.983 | 0.024* |
| (mg/kg) | | | | | |

Water soluble anions (mg/kg)

| | | | | | |
|---|---|---|---|---|---|
| Fluoride | 27.6 | 36.8 | 0.505 | 0.157 | 0.7986 |
| Chloride | 49.7 | 16.0 | 0.044* | 0.832 | 0.0528 |
| Sulfate | 30.2 | 670.0 | 0.186 | 0.557 | 0.2403 |

Water extractable elements (mg/kg)

| | | | | | |
|---|---|---|---|---|---|
| Na | 658.4 | 1235.7 | 0.032* | 0.896 | 0.0375* |
| K | 1.4 | 6.4 | 0.055 | 0.921 | 0.0181** |
| Ca | 12.9 | 2313.0 | 0.017* | 0.953 | 0.0431* |
| Mg | 3.7 | 66.3 | 0.023* | 0.938 | 0.0264* |
| Al | 36.7 | 2.7 | 0.123 | 0.585 | 0.2847 |
| Fe | 0.22 | 0.11 | 0.072 | 0.668 | 0.1986 |

Exchangeable cations (mg/kg)

| | | | | | |
|---|---|---|---|---|---|
| Na | 5416.4 | 2498.2 | 0.047* | 0.768 | 0.1194 |
| K | 49.1 | 54.5 | 0.528 | 0.709 | 0.2056 |
| Ca | 2659.7 | 2654.9 | 0.970 | 0.680 | 0.1833 |
| Mg | 82.8 | 70.6 | 0.562 | 0.138 | 0.7750 |
| CEC (cmol/kg)^{d} | 37.6 | 24.8 | 0.045* | 0.766 | 0.1097 |
| ESP (%)^{e} | 65.5 | 47.2 | 0.007** | 0.883 | 0.0778 |

^{a} Values are means for chemical properties of bauxite residues from each treatment (n = 3)
^{b}Chemical properties of bauxite residues varied significantly between CK and Grass + P treatments were labelled in bold ***, **, * means P < 0.001, P < 0.01 and P < 0.05, respectively;
^{c}Chemical properties posing significant impacts on the bacterial communities in the bauxite residues were labelled in bold, ***, **, * means P < 0.001, P < 0.01 and P < 0.05, respectively using Monte Carol test with 999 permutations;
^{d}cation exchange capacity
^{e}exchange sodium percentage

### Example 2

Bioneutralization of alkaline bauxite residues could be achieved through in situ organic acid production from anaerobic decomposition of carbohydrates-rich organic matters (e.g., plant biomass residues) under saline and alkaline conditions. However, the efficacy and sustainability of bioneutralization in bauxite residues are limited by non-resilient growth and functions of fermentative organoheterotrophic bacteria under the extremely alkaline and saline conditions. This example investigated if by pre-composting carbohydrate-rich plant residues with soil bacteria could enhance the resilience of fermentative bacteria and associated bioneutralization efficacy in strongly alkaline bauxite residues. In this regard, some tolerant bacteria of marine origin are present in soil, but in very minor quantities and largely not effective, until they are enriched and provided the alkaline and saline conditions to activate them. In a 2-week microcosm experiment with bauxite residues (pH˜10.5), it was found that the resilience of functional bacterial groups and bioneutralization efficacy were significantly boosted in plant residues (i.e., SM: sugarcane mulch, LH: Lucerne hay) pre-composted with soil bacteria inoculum. Pre-compositing plant residues with soil microbial inoculum not only recovered 10-20% of the soil bacterial features initially inoculated, but most importantly amplified a highly diverse microbial consortium (feature richness 220-321, dominated by bacteria) in the plant residues. Remediation with precomposted plant residues resulted in pH reduction of 0.8-2.0 units, despite countering effects caused by the alkalinity buffering capacity of alkaline minerals in bauxite residues amended with the pre-composted plant residues. In contrast, the growth medium-based soil bacterial inoculation resulted in pH reduction by only 0.2-0.7 unit in the bauxite residues, with the loss of >99% of the diverse prokaryotic features of the original soil inoculum. As a result, plant residues composted with soil bacteria would be a preferred method to remediate bauxite residues for effective bioneutralization.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

TABLE 2
List of genome resources of functional bacteria in bauxite residues (sourced from both bauxite residues and seawater neutralized bauxite residues)

| | | | | Tolerant | Potential metabolic | Habitat |
|---|---|---|---|---|---|---|
| Phyla | Families | Closest genus | Features | capacity | pathways | distribution |
| Actinobacteria | Cellulomonadaceae | Actinotalea sp. | Heterotrophic, | NaCl: | Cellulose | sludge biofilm |
| | | | Aerobic, | 0-4 | fermentation | reactor |
| | | | Non-motile | pH: | | iron mine, |
| | | | | 6-8 | | rhizobium of |
| | | | | | | halophytes in |
| | | | | | | desert saline |
| | | | | | | soil |
| | | Actinomycetospora | Heterotrophic, | NaCl: | Cellulose | saline soil, |
| | | sp. | Aerobic, | 1-15% | fermentation | tropical |
| | | | Filamentous motile | pH | | rainforest |
| | | | | 6.0-10.5 | | |
| | Nordiopsaceae | Nocardioides sp. | Mesophilic, | NaCl: | Carbohydrate | soil including |
| | | | Heterotrophic, | 0-5% | decomposer | supersaline |
| | | | Motile | pH | | soil, biomass |
| | | | | 7.0-9.0 | | waste; |
| | | | | (up to 12.0) | | waste water, |
| | | | | | | saline lake |
| | Promicromonosporaceae | Xylanimicrobium | Heterotrophic, | pH | Acid producer from | Decay plant |
| | | sp. | Non-motile, | 7.0-7.5 | carbohydrate | tissue |
| | | | Anaerobic | | fermentation, | |
| | | | | | Xylan hydrolization | |
| | | Propionibacterium | Slow growing, | NaCl: | Heterofermentative | Soil |
| | | sp. | Aerotolerant | 0-6.5% | synthesize propionic | Plants |
| | | | | pH | acid | |
| | | | | 5.1-8.5 | | |
| | Streptomycetaceae | Streptomyces sp. | Saprotrophic | NaCl: | Producer a variety of | Soil, |
| | | | | 0-3% | secondary metabolites | Waste water |
| | | | | pH | (antibiotics, enzymes) | |
| | | | | 5.0-9.0 | for extracellular | |
| | | | | | functions | |
| | Nitriliruptoraceae | Nitriliruptor sp. | Haloalkaliphilic | NaCl: | Nitrile (important | Soda lake |
| | | | | 0.4-8% | intermediates for | sediment |
| | | | | pH | synthesis organic | |
| | | | | 8.4-10.6 | compounds) | |
| | | | | | degradation through | |
| | | | | | nitrile hydratase and | |
| | | | | | amidase pathways | |
| Bacteroidetes | Cytophagaceae | Algoriphagus sp. | Heterotrophic, | NaCl: | positive for oxidase, | Seawater, |
| | | | Non-motile, | 0-6% | catalase and b- | Marine |
| | | | Aerobic, | pH | galactosidase activity, | sediment, |
| | | | Saccharolytic | 5.5-9.5 | and utilization | Mud core, |
| | | | | | of D-glucose and | Saline lake |
| | | | | | lactose with organic | cyanobacterial |
| | | | | | acid production | mats |
| | | | | | capacity | |
| | | Cytophaga sp. | Heterotrophic, | NaCl: | Cellulose decomposer | Soil, |
| | | | Anaerobic | 0-6% | | Decay plant |
| | | | | pH 5-9 | | tissue |
| | Flavobacteriia | Flavobacterium sp. | Heterotrophic, | NaCl: | Cellulose | Soil |
| | | | Non-motile, | 0-5% | decomposer, | Marine |
| | | | Aerobic | pH | Acid produced | sediment |
| | | | | 6.5-8.5 | aerobically from | |
| | | | | | carbohydrates | |
| | | Salegentibacter sp. | Heterotrophic, | NaCl: | hydrolysis of cellulose | Ocean |
| | | | Motile, | 0-8% | urea and chitin; | |
| | | | Aerobic | (up to 18%) | acid production; | |
| | | | | pH 5-10 | utilization of inositol, | |
| | | | | | mannitol, sorbitol, | |
| | | | | | malonate and citrate; | |
| | | | | | and production of | |
| | | | | | indole and acetoin | |
| Cyanobacteria | Nostocaceae | Nostoc sp. | Photoautotrophs, | NaCl: | Photosynthesis, | Light exposure |
| | | Anabaena sp. | Heterocystous, | 0.2-5% | produce extracellular | Nutrient-poor |
| | | | Motile, | (up to 18%) | polymer substrates, | soil, |
| | | | | pH: 5-10 | Nitrogen fixation | Rock surface |
| | | | | | | Aquatic habitat |
| | | | | | | (sea, |
| | | | | | | freshwater) |
| | Pseudanabaenaceae | Leptolyngya sp. | Photoautotrophs, | NaCl: | Photosynthesis, | Light exposure |
| | | | Motile with long | 0.2-3% | produce extracellular | saline soil, |
| | | | filaments, | pH: 4-11 | polymer substrates | Rock surface |
| | | | Non-heterocystous | | | Aquatic habitat |
| | | | | | | (sea, |
| | | | | | | freshwater) |
| | Oscillatorium | Phormidium sp. | Photoautotrophs, | NaCl: | Photosynthesis, | Soil, |
| | | | Motile with long | 0.2-5% | produce extracellular | Pool sediment, |
| | | | filaments, | (up to 15%) | polymer substrates | Soda lake, |
| | | | Non-heterocystous | pH: 5-11 | | Marine, |
| | | | | | | sediments |
| Firmicutes | Bacillaceae | Bacillus sp. | Heterotrophic | NaCl: | Highest capacity to | Soda lake |
| | | | | 0.2-8% | degrade hydrocarbon, | |
| | | | | (up to 15%) | Alkane | |
| | | | | pH: | biodegradation and | |
| | | | | 8.5-11.5 | fermentation | |
| | Enterococcacea | Enterococcus sp. | Heterotrophic | NaCl: | Lactic acid bacteria, | soil and |
| | | | | 0.2-6.5% | Wide range organic | sediments, |
| | | | | pH: | compounds | beach sand, |
| | | | | 4.4-9.6 | decomposition and | aquatic and |
| | | | | | synthesis | terrestrial |
| | | | | | | vegetation, and |
| | | | | | | ambient waters |
| Gemmatimonadetes | Gemm-3 | Uncultured | Heterotrophic | Neutral | more likely to be | Compost, |
| | | bacteria | Adapt to low | pH | decomposing organic | Neutral soil |
| | | | moisture, | | matter than fresh | |
| | | | Aerobic | | biomass, | |
| | | | | | polyphosphate | |
| | | | | | accumulation | |
| Proteobacteria | Caulobacteraceae | Brevundimonas sp. | Heterotrophic, | NaCl: | Denitrification | Soil |
| (alpha) | | | Motile, | 0-3% | Oxidase and catalase | Sea sediment, |
| | | | Aerobic | pH: 6-10 | positive | sludge, sand |
| | | | | | | and fresh water |
| | | Caulobacter sp. | Mesophilic and | NaCl: | Cellulose | Aquatic |
| | | | cellulolytic, | 0-2% | decomposition | habitats, both |
| | | | Adapt to redox- | Optimal | | fresh water and |
| | | | fluctuating | pH: | | marine, |
| | | | environments | 7.5-8.5 | | Nutrient poor, |
| | | | | | | Soil |
| | Bradyrhizobiaceae | Balneimonas sp. | Heterotrophic, | NaCl: | Hydrolyse | Soil, |
| | | | Non-motile, | 0-2% | hypoxanthine, | Roots, |
| | | | Aerobic | pH: | Cellulose-producing | Hot spring |
| | | | | 5.0-9.0 | | |
| | Hyphomicrobiaceae | Devosia sp. | Heterotrophic, | NaCl: | hydrolysis of cellulose | Soil |
| | | | Motile, | 0.5-2% | and urea | |
| | | | Aerobic | pH: | | |
| | | | | 6.5-7.5 | | |
| | Rhizobiaceae | Agrobacterium sp. | Heterotrophic, | NaCl: | horizontal gene | Plant roots, |
| | | | Motile, | 0-5% | transfer to cause plant | Soil |
| | | | Aerobic | pH: | tumors | |
| | | | | 6.0-10.0 | hydrolysis of urea and | |
| | | | | | starch | |
| | | | | | catalase and oxidase | |
| | | | | | activity | |
| | Rhodobacteraceae | Albirhodobacter | Heterotrophic | NaCl: | oxidase and catalase | Marine habitats |
| | | sp. | Non-motile, | 1-9% | activities | |
| | | | Facultative anaerobic | pH: | | |
| | | | | 16.0-0 | | |
| | Phyllobacterium | Mesorhizobium sp. | Heterotrophic, | NaCl: | Form roots nodule | Soil, |
| | | | Adapt to both acidic | 0-2% | P dissolution, | Sandstone, |
| | | | and alkaline habitat | pH: | L-tryptophan | Limestone |
| | | | | 3.0-10.0 | metabolism | |
| | Acetobacteraceae | Acetobacter | Heterotrophic, | NaCl: | Acetic acid producing | sugary, acidic |
| | | | Aerobic | 0-1.5% | Sugar fermentation | and alcoholic |
| | | | | pH: | | habitats |
| | | | | 3.0-8.0 | | |
| | Sphingomonadaceae | Kaistobacter sp. | Heterotrophic | na | Organic matter | Plant roots, |
| | | | | | decomposition, | Soil, |
| | | | | | Methane enrichment | Deep seawater |
| | | Sphingomonas sp. | Chemoheterotrophic, | NaCl: | metabolize a wide | Soil, |
| | | | Aerobic | 0-1% | variety of carbon | Water, |
| | | | | pH: | sources (including | Plant roots, |
| | | | | 4-12 | pollutants) | Nutrients poor |
| Proteobacteria | Alcaligenaceae | Alcaligenes sp. | Heterotrophic | NaCl: | Hydrolyse | Saline soil |
| (beta) | | | Motile, | 0-10%, | carbohydrate catalse, | Saline water |
| | | | Aerobic | pH: | nitrate reduction and | |
| | | | | 6-11 | oxidase positive. | |
| | | | | | Produce hydrogen | |
| | | | | | sulfide | |
| | Oxalobacteraceae | Pseudoduganella | Heterotrophic, | NaCl: | catalase and oxidase | Lagoon |
| | | sp. | Motile, | 0-3%, | positive, | sediment |
| | | | Aerobic | pH: | chitin degrader | Soil |
| | | | | 5-9 | | rhizosphere |
| Proteobacteria | Alteromonadacea | Cellvibrio sp. | Heterotrophic, | NaCl: | cellulose, xylan, | Soil, |
| (gamma) | | | Aerobic | 0-2.5%, | starch, and chitin | Fresh water |
| | | | | pH: | degraders, | |
| | | | | 6-10 | Nitrate reduction | |
| | Moraxellaceae | Acinetobacter sp. | Heterotrophic, | NaCl: | Aromatic compounds | Soil, |
| | | | Non-motile | 2-5%, | decomposer, | Water |
| | | | Aerobic | pH: | Catalase positive | |
| | | | | 4.5-9.5 | | |
| | Enterobacteriaceae | Enterobacter sp. | Heterotrophic, | NaCl: | Synthesize an enzyme | Saline soil, |
| | | | Mobile, | up to 7% | known as ornithine | Seawater, |
| | | | Facultatively | pH: 5-9 | decarboxylase, | Halophytes |
| | | | anaerobic | | Some strains | rhizosphere, |
| | | | | | symbiotic nitrogen | Waste water |
| | | | | | fixation | |
| | | Klebsiella sp. | Heterotrophic, | NaCl: | Carbonhydrate | Soil, |
| | | | With polysaccharide | up to 7.5% | metabolisms, | rhizosphere |
| | | | based capsule, | pH: 4-10 | Dissolve phosphate, | |
| | | | Facultatively | | synthesized | |
| | | | anaerobic | | sideropheres. | |
| | | | | | Some strains | |
| | | | | | symbiotic nitrogen | |
| | | | | | fixation | |
| | | Citrobacteria sp. | | NaCl: | Utilization of citrate, | Soil, |
| | | | | 0.1-4% | Lactose fermentation | Water, |
| | | | | pH: 3-11 | Accumulation | Wastewater |
| | | | | | uranium | |
| | Halomonadaceae | Halomonas sp. | Heterotrophic, | NaCl: | Nitrate reduction, | Estuaries, |
| | | | Mobile, | 15-25% | Carbohydrate | Oceans |
| | | | Facultatively aerobic | pH: 3-11 | fermentation | Soda lakes |
| | | | | | Catalase positive | |
| | Psedomonadaceae | Pseudomonas sp. | Heterotrophic, | NaCl: | Oxidase and catalase | Soil, |
| | | | Mobile, | up to 25% | positive, | Water, |
| | | | Aerobic | pH: | Decompose diverse | Plant |
| | | | | 4.5-9.5 | organics, including | |
| | | | | | aromatic carbon | |
| | Xanthomonadaceae | Aquimonas sp. | Mesophilic, | NaCl: | Oxidase and catalase | Warm spring |
| | | | Heterotrophic, | up to 2% | positive, | water |
| | | | Mobile, | pH: 6-11 | Acid production from | |
| | | | Aerobic | | cellulose | |

1. A method for treating bauxite residue contained in a storage facility comprising adding a mixture containing (a) a source of organic carbon, (b) a source of phosphorous or a source of phosphate and (c) a source of calcium, to the bauxite residue, wherein haloalkaliphilic bacteria are also present.

2. A method as claimed in claim 1 further comprising adding a source of S or a source of sulphate to the bauxite residue.

3. A method as claimed in claim 1:
(a) the bauxite residue contains microbes well adapted to highly saline and alkaline habitat, or marine microbes, or tolerant and marine origin haloalkaliphilic bacteria or haloalkaliphilic organotrophic bacteria, preferably of marine origin, and adding the mixture promotes growth of the microbes; or
(b) further comprising adding a source of microbes well adapted to highly saline and alkaline habitat, or marine microbes, or tolerant and marine origin haloalkaliphilic bacteria or haloalkaliphilic organotrophic bacteria, preferably of marine origin of microbes well adapted to highly saline and alkaline habitat, or marine microbes, to the bauxite residues.

4. (canceled)

5. (canceled)

6. A method as claimed in claim 1 wherein the mixture is applied to the bauxite residue by spreading the mixture on top of the bauxite residue in the storage facility and ploughing or otherwise mixing the mixture into the bauxite residue.

7. A method as claimed in 1 wherein the source of organic carbon comprises plant biomass residues or plant mulch:
(a) having relatively high levels of total carbohydrates and an N:C ratio suitable for intensive organic acid production; or
(b) having a carbon:nitrogen ratio no higher than 80:1, or from 10:1 to 60:1, or from 20:1 to 40:1.

8. (canceled)

9. A method as claimed in claim 1 wherein the method comprises adding a mixture containing green plant litter and/or green plant biomass and superphosphate fertiliser to the bauxite residue.

10. A method as claimed in 1 wherein the source of organic carbon, such as plant litter or plant mulch, is added in an amount of from 10% to 60% volume/volume of the amount of bauxite residue to be treated.

11. A method as claimed in claim 1 wherein the method comprises ploughing or tilling the mixture into the bauxite residue and irrigating the bauxite residue.

12. A method as claimed in claim 1 wherein phosphorous-rich calcium-minerals, such as superphosphate, are added to the bauxite residue and the phosphate-rich calcium-minerals are added to the bauxite residue in an amount of from 1 to 30% weight/weight ratio to the bauxite residue.

13. A method as claimed in claim 1 wherein the source of P and the source of Ca comprises phosphorous rich calcium minerals, such as superphosphate, and the phosphorus rich calcium minerals contain from 5 to 10% P, by weight (calculated on the basis of P present), and the phosphorous rich calcium minerals, such as superphosphate, has a phosphorous solubility of greater than 50%, or greater than 60%, or greater than 70%, or greater than 80%.

14. A method as claimed in claim 1 wherein the source of organic carbon, the source of phosphorous or phosphate and the source of calcium and the source of sulphur or sulphate are mixed with the bauxite residue to a depth of from about 20 cm to about 5 m, or from about 50 cm to about 2 m, or from about 50 cm to about 1.5 m, or from about 50 cm to about 1 m.

15. A method as claimed in claim 1 wherein the method comprises preparing a mixture comprising the source of organic carbon, the source of phosphorous or phosphate and the source of calcium and applying that mixture to the bauxite residue, or the source of organic carbon is applied to the bauxite residue separately to the source of phosphorous or phosphate and source of calcium, or the source of organic carbon is applied to the bauxite residue and then the source of phosphorous or phosphate and the source of calcium is applied, or the source of phosphorous or phosphate and the source of calcium is applied and the source organic carbon is subsequently applied.

16. A method as claimed in claim 1 further including the step of inoculating plant material with tolerant and marine origin haloalkaliphilic bacteria and allowing the tolerant and marine origin haloalkaliphilic bacteria to build up in the plant material to form an inoculum or composted plant mulch and subsequently adding the inoculum or composted plant mulch to the bauxite residue.

17. A method as claimed in claim 16 wherein:
(a) the tolerant and marine origin haloalkaliphilic bacteria are added to plant material and the plant material allowed to sit for from 1 week to 4 weeks, or from 2 weeks to 4 weeks, or for about 2 weeks, to allow for the build-up the tolerant and marine origin haloalkaliphilic bacteria in the plant material; or
(b) the inoculum or composted plant mulch containing the inoculum is added to the other organic material added to the bauxite residue, or applied separately to the bauxite residue to other components added by the method; or
(c) the inoculum or composted plant mulch comprises from 0.1 to 10% volume/volume of the source of organic material or plant mulch added to the bauxite residue.

18. (canceled)

19. (canceled)

20. A method as claimed in claim 1 further including adding elemental sulphur to the bauxite residue.

21. A method as claimed in claim 20 wherein the elemental sulphur is added from 12 to 18 months after the original treatment and/or the elemental sulphur is added in an amount of from 1-10% S weight/weight of the bauxite residue, or from 100-2000 kg S/hectare.

22. A method as claimed in claim 1 wherein the step of adding a mixture containing (a) a source of organic carbon, (b) a source of phosphorous or a source of phosphate, (c) a source of calcium, and a source of sulphur or sulphate to the bauxite residue is repeated one or more times.

23. A method for treating bauxite residue contained in a storage facility comprising adding a mixture containing (a) a source of organic carbon, (b) a source of phosphorous or a source of phosphate, (c) a source of calcium, and a source of sulphur or sulphate to the bauxite residue, to thereby promote growth of microbes well adapted to highly saline and alkaline habitat, or to promote growth of marine microbes, or to promote growth of tolerant and marine origin haloalkaliphilic bacteria, or to promote growth of haloalkaliphilic organotrophic bacteria, preferably of marine origin.

24. (canceled)

25. A soil amendment for amending bauxite residue in a storage facility, the soil amendment comprising a source of phosphorous or phosphate and a source of calcium, and haloalkaliphilic organotrophic bacteria.

26. The soil amendment of claim 25, the soil amendment further comprising a source of organic carbon and a source of sulphur or sulphate.
